(19) United States
(12) Patent Application Publication
(10) Pub. No.: US 2019/0098388 A1
(43) Pub. Date: Mar. 28, 2019

(54) Earphones With Sensors

(71) Applicant: Apple Inc., Cupertino, CA (US)

(72) Inventors: Gareth J. Powell, Culver City, CA (US); Marc-Angelo P. Carino, Los Angeles, CA (US); Chen Na, Cerritos, CA (US)

(21) Appl. No.: 16/019,432

(22) Filed: Jun. 26, 2018

Related U.S. Application Data
(60) Provisional application No. 62/562,987, filed on Sep. 25, 2017.

(51) Int. Cl. H04R 1/10; H04R 5/033

(52) U.S. Cl. CPC H04R 1/105; H04R 1/1066; H04R 2201/10; H04R 2460/03; H04R 5/0335

(57) ABSTRACT

An electronic device such as an earphone may have sensor circuitry. The sensor circuitry may include optical proximity sensors and capacitive sensor circuitry. An ear support structure such as an ear hook may be used to hold the earphone adjacent to an ear of a user. In this position, a speaker in the earphone may be used to present audio to the user. The ear hook may be formed from an insulating elastomeric polymer. A stainless steel wire or other bendable structural support member may be embedded within the elastomeric polymer. The bendable member may hold the ear hook in a desired bent shape after bending by the user. The capacitive sensor circuitry may include one or more capacitive sensor electrodes coupled to capacitance-to-digital converter circuitry. Control circuitry may activate the optical proximity sensors in response to detection of a capacitance to confirm that the earphone is being worn.

This application claims the benefit of provisional patent application No. 62/562,987, filed Sep. 25, 2017, which is hereby incorporated by reference herein in its entirety.

### BACKGROUND

This relates generally to electronic devices, and, more particularly, to wearable electronic devices such as earphones.

Cellular telephones, computers, and other electronic equipment may generate audio signals for media playback operations and telephone calls. Speakers in these electronic devices may be used to play audio for a user. Accessories such as earphones may also be used to play audio for a user. Earphones and other devices with speakers may contain audio processing circuitry and communications circuitry. Some earphones contain batteries to support wireless operation.

It can be challenging to control the operation of devices such as earphones. For example, it may be difficult or impossible to automatically adjust the operation of an earphone to reduce power for extended battery life or to dynamically adjust media playback.

### SUMMARY

An electronic device such as an earphone may have sensor circuitry. During operation of the earphone, control circuitry in the earphone may use information from the sensor circuitry to automatically adjust the earphone. For example, the earphone may be placed in a low power mode when not in active use, media may be paused or resumed based on whether the earphone is being worn, and/or other actions may be taken.

The sensor circuitry in an earphone may include optical proximity sensors and capacitive sensor circuitry. An ear support structure such as an ear hook may be used to hold the earphone in position adjacent to an ear of a user. In this position, a speaker in the earphone may be used to present audio to the user.

The ear hook may be formed from an insulating elastomeric polymer. A stainless steel wire or other bendable support structure may be embedded within the elastomeric polymer. The bendable support structure may hold the ear hook in place after bending by the user.

The capacitive sensor circuitry may include one or more capacitive sensor electrodes coupled to capacitance-to-digital converter circuitry. Control circuitry may activate the optical proximity sensors in response to detection of a capacitance to confirm that the earphone is being worn and may take other action base on capacitive sensor circuitry measurements.

The capacitive sensor electrodes may be formed from a metal bendable support structure, metal traces on a flexible printed circuit, and/or conductive polymer embedded within the insulating polymer of the ear hook.

### BRIEF DESCRIPTION OF THE DRAWINGS

FIG. 1 is a schematic diagram of an illustrative system with earphones in accordance with an embodiment.

FIG. 2 is a perspective view of an illustrative earphone in accordance with an embodiment.

FIG. 3 is a flow chart of illustrative operations involved in using earphones with sensors in accordance with an embodiment.

FIGS. 4 and 5 are diagrams of illustrative sensing circuits in accordance with embodiments.

FIG. 6 is a diagram of an illustrative earphone having optical sensors and an ear hook with a capacitive sensor in accordance with an embodiment.

FIG. 7 is a side view of an illustrative ear hook with sensors mounted on an ear of a user in accordance with an embodiment.

FIG. 8 is a cross-sectional side view of an ear hook sensor in accordance with an embodiment.

FIG. 9 is a diagram of an illustrative ear hook with a segmented sensor in accordance with an embodiment.

FIGS. 10, 11, 12, 13, 14, and 15 are cross-sectional side views of illustrative ear hook sensors in accordance with an embodiment.

FIGS. 16, 17, and 18 are cross-sectional side views of illustrative ear hooks with capacitive sensor electrodes formed using flexible printed circuits in accordance with an embodiment.

FIG. 19 is a diagram of an illustrative flexible printed circuit with segmented electrodes and tabs in accordance with an embodiment.

FIG. 20 is a diagram of an illustrative flexible printed circuit with a tab in accordance with an embodiment.

FIG. 21 is a diagram of an illustrative flexible printed circuit with flexibility enhancement recesses in accordance with an embodiment.

FIGS. 22, 23, and 24 are diagrams of illustrative flexible printed circuit sensor electrodes in accordance with embodiments.

### DETAILED DESCRIPTION

Electronic devices may have components such as speakers for presenting audio to a user. The electronic devices may be wearable devices such as earphones. The earphones may be worn over the ear or on the ear of a user. Ear hooks or other support structures may be used to help hold earphones adjacent the ears of a user.

Sensors may be used in earphones to gather input from a user and from the environment. For example, optical sensors may be used to determine whether earphones are being worn on a user or are at rest on a tabletop (as an example). Capacitive sensors can also be used in earphones. For example, capacitive sensors may be formed using capacitive sensor electrodes in the ear hooks of a pair of earphones.

The capacitive sensors may be used to sense whether the earphones are being worn by a user. Capacitive sensors may consume significantly less power than optical sensors, so, in some configurations, optical sensors in a pair of earphones can be powered down when not in use and then turned on in response to output from capacitive sensors in the earphones. Capacitive sensors can also be used as stand-alone sensors (e.g., capacitive sensors can be used in earphones that do not use optical sensing).

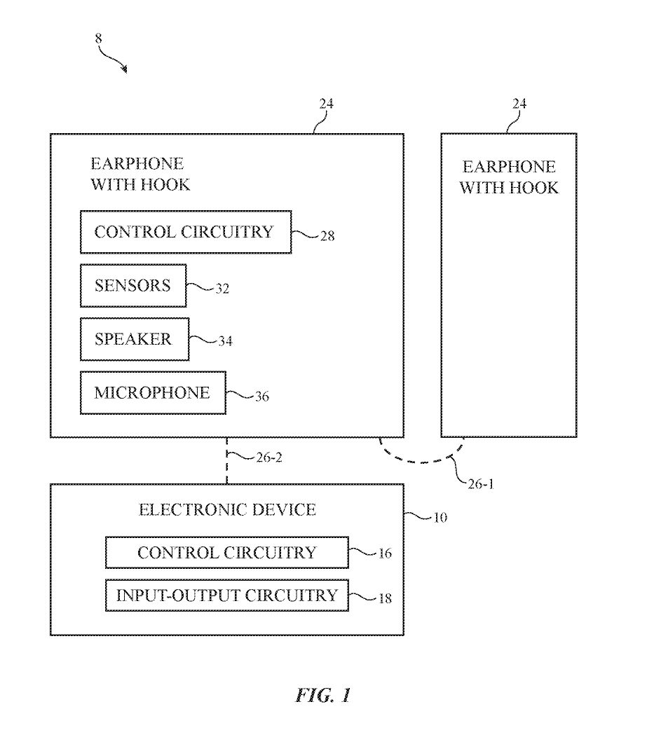

A schematic diagram of an illustrative system with electronic devices such as earphones is shown in FIG. 1. As shown in FIG. 1, system 8 may contain a pair of earphones 24 (e.g., left and right earphones for a user's left and right ears). If desired, earphones 24 may communicate with each other using a cable or wirelessly, as illustrated by path 26-1. When a cable is used to join earphones 24, the cable may help hold earphones 24 to each other. Earphones 24 may have a cable that plugs into a host device such as electronic device 10 and/or may have wireless communications circuitry for communicating wirelessly with device 10. Wired and/or wireless connections such as these are illustrated as path 26-2 in FIG. 1.

Host electronic device 10 may be a cellular telephone, may be a computer, may be a wristwatch device or other wearable equipment, may be part of an embedded system (e.g., a system in a plane or vehicle), may be part of a home network, or may be any other suitable electronic equipment.

As shown in FIG. 1, earphones 24 and electronic device 10 may have control circuitry 28 and 16. Control circuitry 28 and 16 may include storage and processing circuitry for supporting the operation of earphones 24 and device 10. The storage and processing circuitry may include storage such as hard disk drive storage, nonvolatile memory (e.g., flash memory or other electrically-programmable-read-only memory configured to form a solid state drive), volatile memory (e.g., static or dynamic random-access-memory), etc. Processing circuitry in control circuitry 28 and 16 may be used to control the operation of the equipment of system 8. The processing circuitry may be based on one or more microprocessors, microcontrollers, digital signal processors, baseband processors, power management units, audio chips, application specific integrated circuits, etc.

Device 10 may have input-output circuitry 18. Input-output circuitry 18 may include wired communications circuitry and wireless communications circuitry (e.g., radio-frequency transceivers) for supporting communications with wearable devices such as earphones 24 or other wireless wearable electronic devices via wired and/or wireless links. Earphones 24 may have wireless communications circuitry in control circuitry 28 for supporting communications with the wireless communications circuitry of device 10. Earphones 24 may also communicate with each other using wireless circuitry.

Input-output circuitry 18 may be used to allow data to be supplied to device 10 and to allow media and other data to be provided from device 10 to external devices such as earphones 24. Input-output devices in circuitry 18 may include buttons, joysticks, scrolling wheels, touch pads, key pads, keyboards, microphones, speakers, displays (e.g., touch screen displays), tone generators, vibrators (e.g., piezoelectric vibrating components, etc.), cameras, sensors, light-emitting diodes and other status indicators, data ports, etc. A user can control the operation of device 10 by supplying commands through the input-output devices and may receive status information and other output from device 10 using the output resources of input-output devices. If desired, some or all of these input-output devices may be incorporated into earphones 24.

Each earphone 24 may have one or more sensors 32 (e.g., capacitive sensors, optical proximity sensors that include light-emitting diodes for emitting infrared light or other light and that include light detectors that detect corresponding reflected light, temperature sensors, force sensors, pressure sensors, magnetic sensors, strain gauges, gas sensors, ambient light sensors, sensors for measuring position and/or orientation such as accelerometers, compasses, and/or gyroscopes, etc.). Each earphone 24 may also have additional components such as speaker 34 and microphone 36. Speakers 34 may play audio into the ears of a user. Microphones 36 may gather audio data such as the voice of a user who is making a telephone call and/or ambient noise information (e.g., for noise cancellation).

If desired, an accelerometer in earphones 24 may detect when earphones 24 are in motion or are at rest. During operation of earphone 24, a user may supply tap commands (e.g., double taps, triple taps, other patterns of taps, single taps, etc.) that are detected by an accelerometer to control the operation of earphones 24. Buttons and other devices may also be used in gathering user input.

Earphones 24 may include capacitive sensors that gather capacitive sensor readings (e.g., capacitive proximity sensor readings) and/or may include optical proximity sensors that gather optical proximity sensor readings. This data may be gathered when processing tap commands to avoid false tap detections. Information from these sensors and/or other sensors may also be used in determining the current operating mode of earphones 24 (e.g., whether earphones 24 are stowed in a case, are at rest on a table, are in one or both ears of a user, are being handled by a user, etc.). Information on the current operating mode of the earphones may be used in adjusting audio playback, controlling power management functions (e.g., placing earphones 24 in a low power sleep mode when not in use to play audio for a user), and/or taking other suitable actions in system 8.

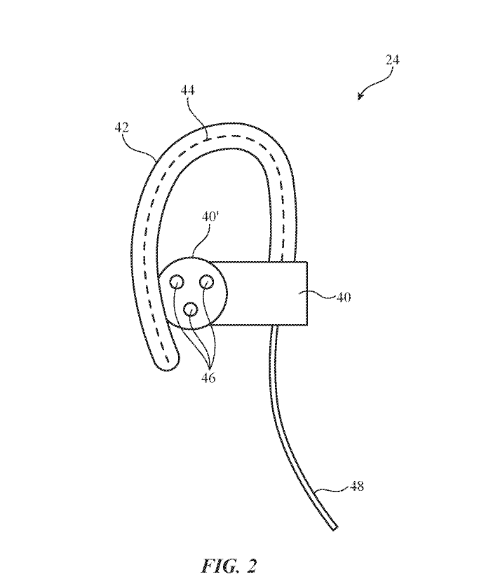

FIG. 2 is a perspective view of an illustrative electronic device such as an earphone. As shown in FIG. 2, earphone 24 may include a housing such as housing 40. Control circuitry 28 and other components of earphone 24 may be mounted in housing 40. Housing 40 may have walls formed from plastic, metal, ceramic, glass, sapphire or other crystalline materials, fiber-based composites such as fiberglass and carbon-fiber composite material, natural materials such as wood and cotton, other suitable materials, and/or combinations of these materials. Housing 40 may have a portion such as portion 40′ that houses speaker 34 and a portion that is configured to help hold earphone 24 adjacent to a user's ear such as hook portion (earphone hook) 42 or other support structure.

Hook 42 may be formed from elastomeric polymer such as silicone or other materials. A bendable structure such as a bendable wire (e.g., an elongated stainless steel member or other bendable support structure) may run the length of hook 42. The bendable structure may be used to help hold hook 42 in a desired bent shape into which hook 42 has been bent by a user in accordance with the user's personal preference (e.g., to fit the user's ear). The bendable wire or other bendable structure may, if desired, be embedded within elastomeric polymer (e.g., molded polymer). The wire or other conductive structures may be used in forming one or more capacitive sensor electrodes such as electrode 44. An optional cable such as cable 48 may be used in forming path 26-1 and/or path 26-2 of FIG. 1.

During operation, a capacitive sensor formed using electrodes such as electrode 44, optical proximity sensors 46, and/or other sensors may be used in monitoring for the presence of a user's ear adjacent to earphones 24. When a user's ear is detected, suitable action can be taken by control circuitry 28 (e.g., circuitry can be turned on or off, media playback can be paused, resumed, and/or otherwise adjusted, etc.).

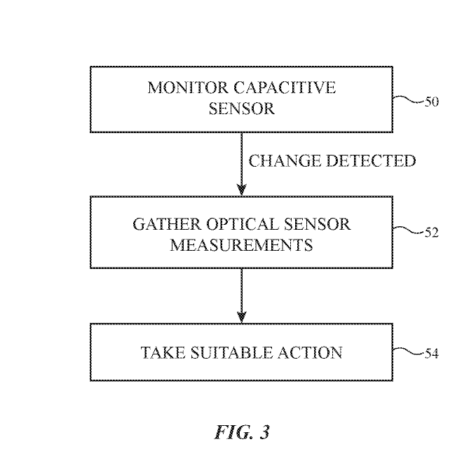

To conserve power, it may be desirable to use capacitive sensing for initial detection operations, followed by use of optical proximity sensing for confirmation that an ear is present. This type of arrangement is shown in the flow chart of FIG. 3. As shown in FIG. 3, earphones 24 may initially use a capacitive sensor to monitor for the presence of a user's ear adjacent to electrode 44 (the operations of block 50). In response to detecting that the user's ear is present (e.g., in response to detecting a capacitive sensor signal that is greater than a predetermined threshold), control circuitry 28 can tentatively assume that a user's ear is present and can proceed to the operations of block 52 for confirmation. During the operations of block 52, optical proximity sensors 46 (FIG. 2) may be used to confirm whether or not earphones 24 are adjacent to the user's ear. In response to determining that earphone 24 is being worn (or is not being worn) by a user, control circuitry 28 and/or control circuitry 16 can take suitable action (the operations of block 54). During block 54, control circuitry 28 and/or control circuitry 16 may, for example, play media for the user through speaker(s) 34, etc. If it is determined that a user's ear is not present, optical sensors 46 and other components in earphones 24 can be turned off to conserve power.

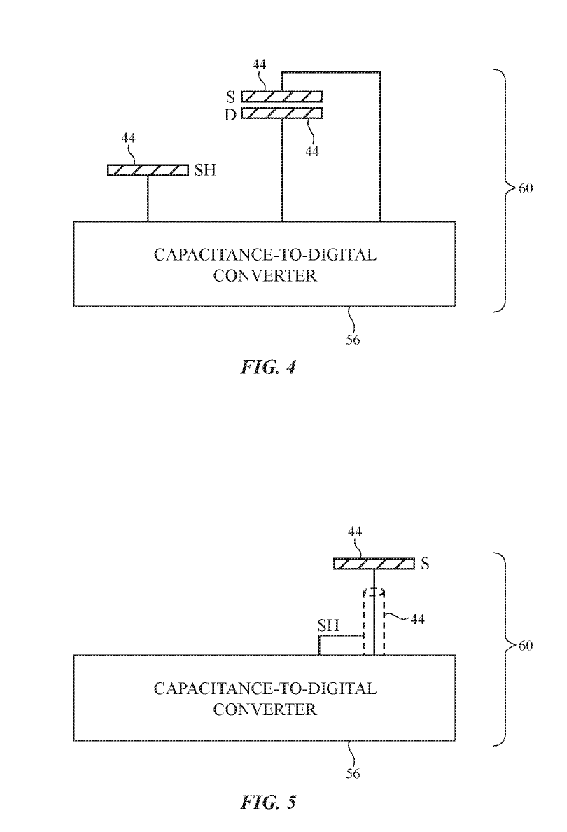

Illustrative capacitive sensor configurations that may be used for the capacitive sensors of earphones 24 are shown in FIGS. 4 and 5. In the example of FIG. 4, capacitive sensor 60 includes electrodes 44 such as sense electrode S, drive electric D, and optional shield electrode SH. Capacitance-to-digital converter 56 gathers capacitance readings using electrodes 44 and supplies corresponding digitized capacitive sensor output to control circuitry 28. Capacitive sensor 60 of FIG. 4, which may sometimes be referred to as a touch mode sensor, may be used to gather self-capacitance or mutual capacitance measurements. Capacitive sensor 60 of FIG. 5, which may sometimes be referred to as a proximity mode sensor, has electrodes 44 such as sense electrode S and shield SH (e.g., a shield that shields part of the signal path for sense electrode S).

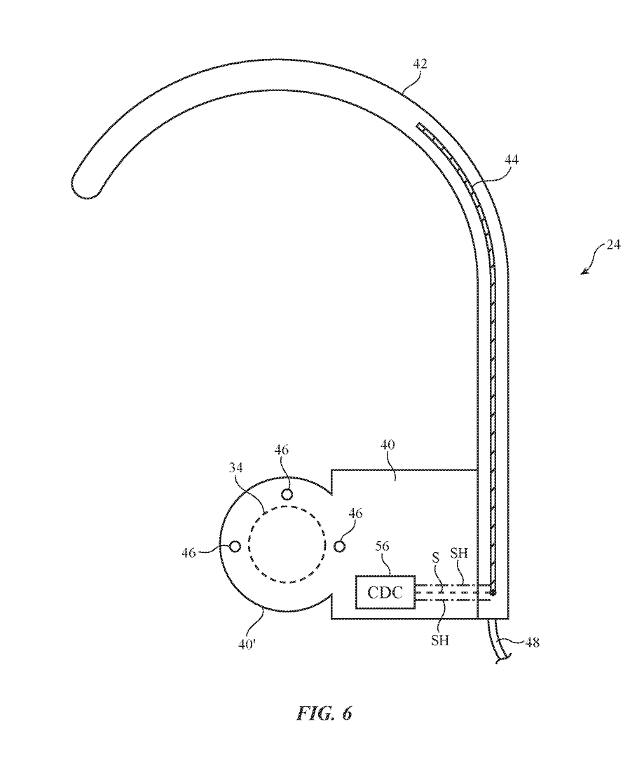

FIG. 6 is a diagram showing how capacitive sensor electrode 44 may run along the longitudinal axis of ear hook 42 (e.g., embedded in an elastomeric polymer member that forms the body of ear hook 42). Electrode 44 may be formed on a flexible printed circuit, may be formed from conductive polymer (e.g., conductive elastomeric polymer), may be formed from one or more wires, may be formed from a bendable stainless steel member (e.g., a bendable structural member for ear hook 42), and/or other may be formed from other conductive electrode structures.

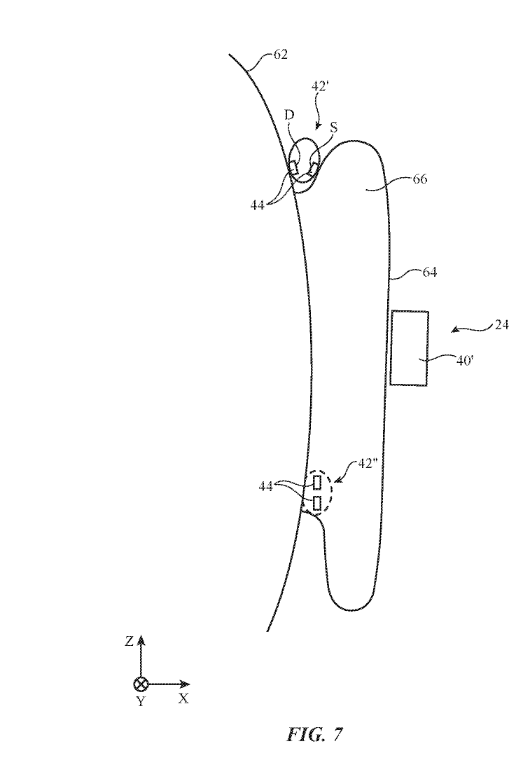

As shown in FIG. 7, electrodes 44 (e.g., sense electrode S and drive electrode D, etc.) may have different orientations at different locations along the length of ear phone 24. In the illustrative arrangement of FIG. 7, earphone 24 is being worn by a user. Portion 42′ of hook 42 is located between helix 66 of the user's ear 64 and the user's head 62 at the top of the user's ear. Portion 42″ of hook 42 is located along a lower portion of the user's ear. In portion 42′, electrodes 44 include a drive electrode D that faces head 62 and a sense electrode S that faces ear 64. This helps the electrodes 44 in portion 42′ detect when hook 42 is being worn by the user. In portion 42″ electrodes 44 both face head 62, as helix 66 is not present. The use of individualized sensor electrode orientations in different locations along the length of hook 42 may help enhance sensor accuracy (e.g., to enhance accuracy in determining whether earphone 24 is being worn by a user).

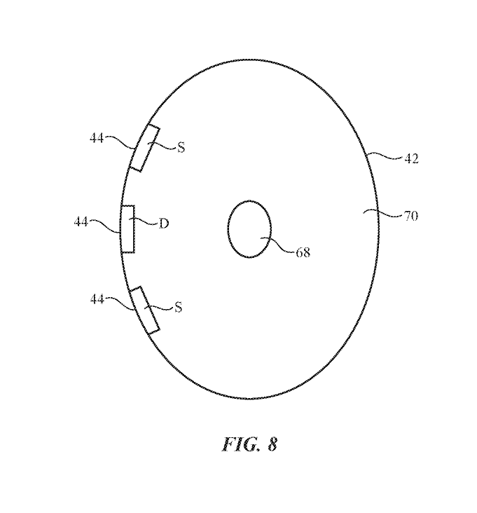

FIG. 8 is a cross-sectional side view of an illustrative ear hook showing how multiple sense electrodes S may flank a central drive electrode D. As shown in FIG. 8, an optional grounded ear hook supporting structure such as wire 68 (e.g., stainless steel wire or other bendable conductive structure) may be included in ear hook 42. Elastomeric material 70 or other dielectric may surround grounded wire 68. If desired, multiple drive electrodes may flank a central sense electrode. Sets of sense and drive electrodes may also be distributed around the circumference of ear hook 42, if desired.

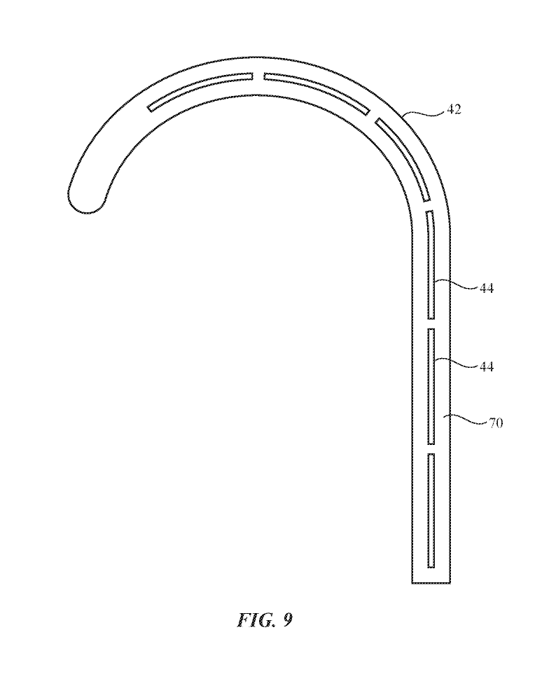

As shown in FIG. 9, the conductive structures in hook 42 may be segmented to form a series of electrodes 44. Electrodes 44 may be arranged in sequence along the length of hook 42 and/or around the circumference (periphery) of hook 42. This allows control circuitry 28 to gather spatially sensitive capacitive sensor readings. The use of spatially sensitive capacitive sensor measurements may help control circuitry 28 determine when a sensor output signal is associated with an inadvertent finger touch or other user touch of earphone 24 or is instead associated with the wearing of earphone 24 on the ear of a user. If desired, the signals from some or all of a series of segmented electrodes may be added together when it is desired to obtain a single “proximity” sensor output that is relatively sensitive to the proximity of nearby objects. Capacitance-to-digital converter sensitivity may be lowered when ear hook 42 is on the ear of a user and may be raised when hook 42 is off of the ear to provide sufficient signal gain.

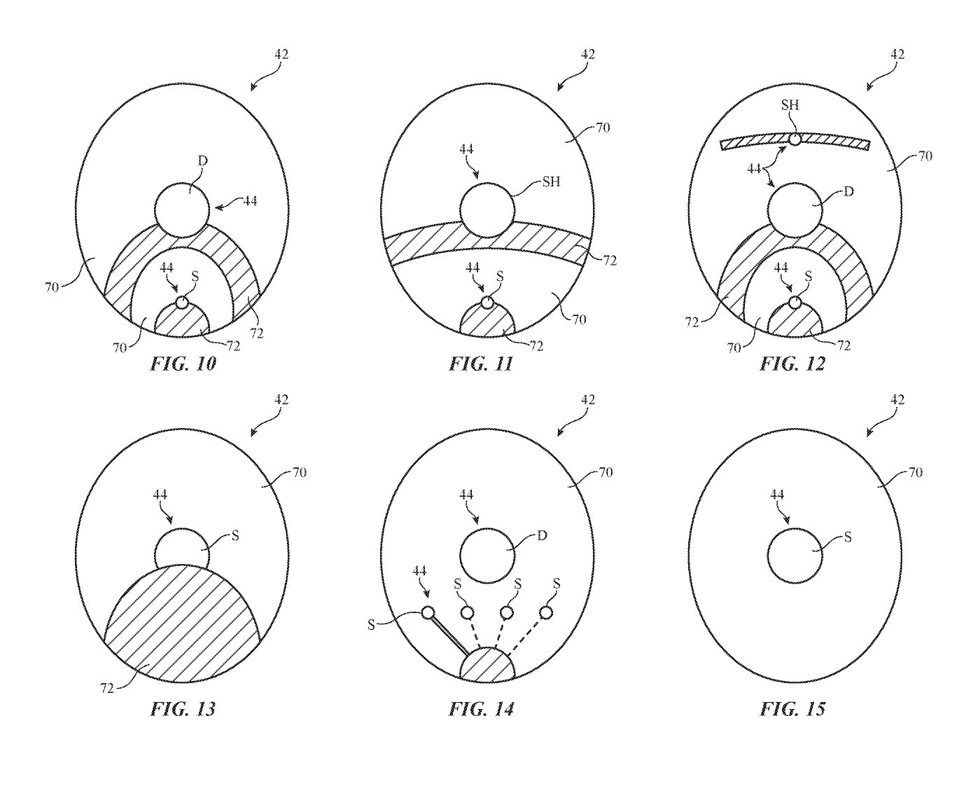

FIGS. 10, 11, 12, 13, 14, and 15 are cross-sectional side views of illustrative ear hook capacitive sensor electrode configurations. As shown in these examples, some or all of electrodes 44 may be formed using conductive polymer such as conductive polymer 72. Conductive polymer 72 may be incorporated into ear hook 42 by partially or fully embedding conductive polymer in non-conductive material such as insulating polymer 70 or other dielectric. Conductive polymer 72 may be used to enlarge the size of electrodes 44 while achieving a desired sensor layout. Conductive polymer 72 may be sufficiently flexible to bend when a user bends ear hook 42 to reconfigure ear phone 24. At the same time, conductive polymer 72 may be sufficiently conductive to serve as a capacitive sensor electrode or a portion of a capacitive sensor electrode. Other portions of electrodes 44 (see, e.g., sense electrode S, drive electrode D, and shield electrode SH of FIGS. 10, 11, 12, 13, 14, and 15) may be formed from wires or other conductive structures (e.g., non-polymer structures). If desired, one or more of these conductive structures (e.g., the centermost structure) may be bendable stainless steel supporting members such as wire 68 of FIG. 8.

The illustrative configurations of FIGS. 10 and 11 have drive electrodes D and sense electrodes S shorted respectively to portions of conductive polymer 72. The illustrative configuration of FIG. 12 includes shield SH shorted to an electrode structure formed from conductive polymer 72 in addition to a drive electrode D and sense electrode S. In FIG. 13, hook 42 includes sense electrode S formed from a wire member and a conductive polymer 72 that is shorted to the wire member to form an enlarged sense electrode. In the example of FIG. 14, sense electrode S has multiple wires that run along the length of ear hook 42 (e.g., within insulating polymer 70). At various locations along the length of ear hook 42, connecting paths short sense electrode wires S to different respective elastomeric pads formed from conductive polymer 72. This forms a segmented series of sense electrodes along the length of hook 42. FIG. 15 is an illustrative configuration in which conductive polymer 42 has been omitted and sense electrode S serves as the only electrode 44 for the capacitive sensor.

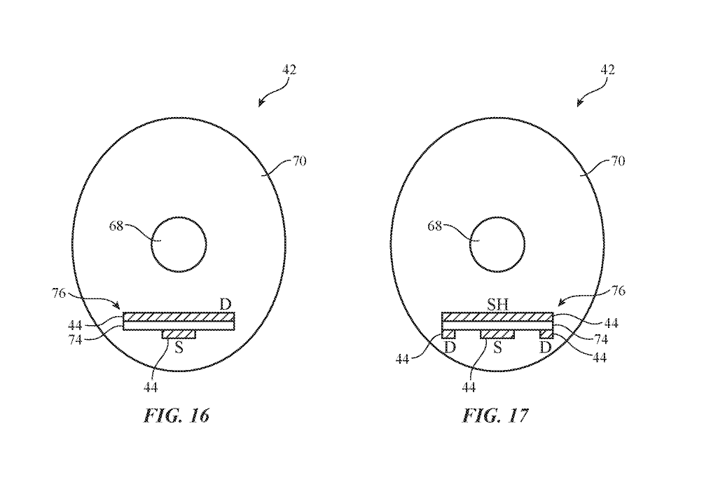

If desired, capacitive sensor electrodes 44 may be formed partly or fully using flexible printed circuits. As shown in FIG. 16, a flexible printed circuit such as flexible printed circuit 76 may be embedded within insulating polymer 70 of ear hook 42. Flexible printed circuit 76 may run along the length of ear hook 42. Substrate 74 of flexible printed circuit 76 may be formed from a sheet of polyimide or a layer of other flexible insulating polymer material. Metal traces may be formed on the front and/or rear surfaces of flexible printed circuit 76 (or in other layers of a multilayer flexible printed circuit). These metal layers may form electrodes 44. In the example of FIG. 16, electrodes 44 include an inwardly facing drive electrode D and an outwardly facing sense electrode S. Supporting wire 68 may be formed from a bendable metal. In the example of FIG. 17, flexible printed circuit 76 has electrodes 44 that form an inwardly facing shield SH and an outwardly facing sense electrode S flanked by a pair of outwardly facing drive electrodes D.

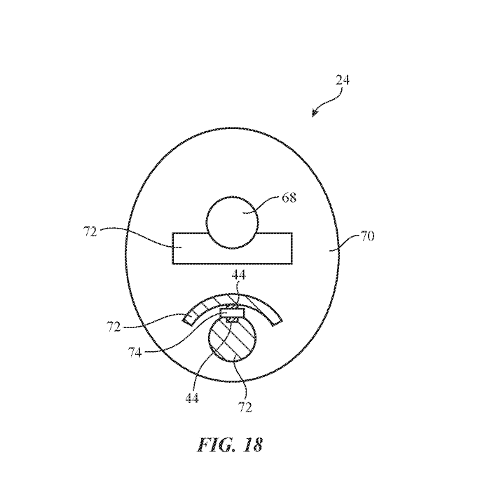

FIG. 18 is a cross-sectional side view of ear hook 42 in an illustrative configuration that includes both conductive polymer portions 72 (to enhance the size and/or adjust the shape of the electrodes) and a flexible printed circuit 76. Flexible printed circuit metal traces on opposing sides of flexible printed circuit substrate 74 may be shorted to respective portions of conductive polymer 72 to form electrodes 44. If desired, metal support member 68 may be shorted to a region of conductive polymer 72 to form a capacitive sensor electrode.

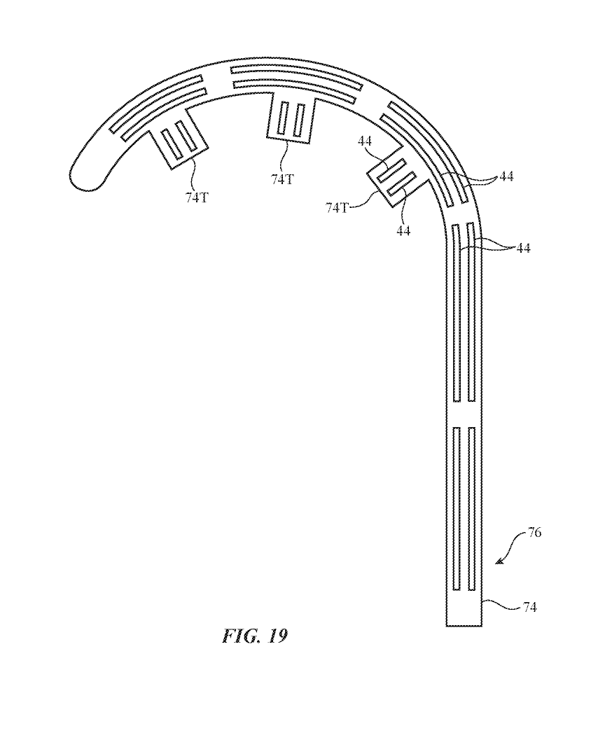

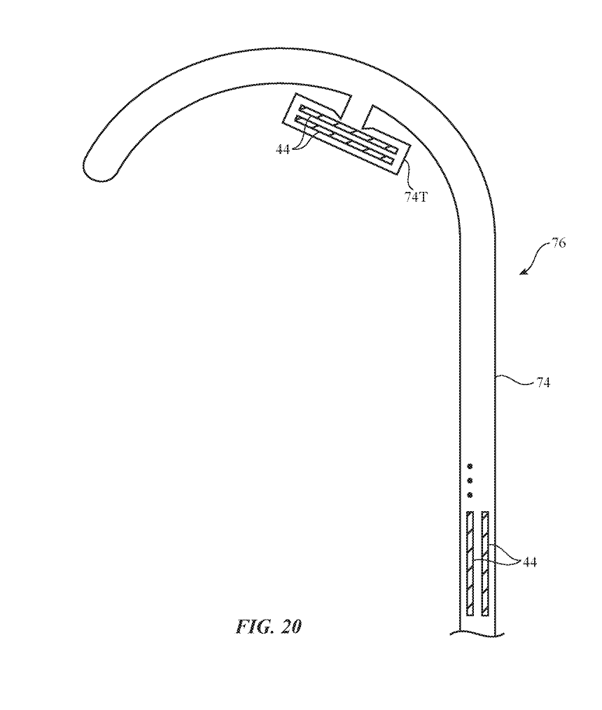

FIG. 19 shows how electrodes 44 may be formed in segments and/or other shapes extending along the length of flexible printed circuit substrate 74 in flexible printed circuit 76. If desired, some of electrodes 44 may be formed on protruding portions of flexible printed circuit substrate 74 such as tabs 74T. Tabs 74T may wrap circumferentially around hook 42 when printed circuit 76 is embedded in insulating polymer 70. If desired, flexible printed circuit substrate 74 of FIG. 19 may be straight (e.g., so that flexible printed circuit 74 may be bent out of the plane of FIG. 19 without introducing stresses into electrodes 44). Another illustrative arrangement for flexible printed circuit 76 is shown in FIG. 20 (e.g., in a configuration in which protrusion 74T forms a T-shaped spur from the main strip of flexible printed circuit substrate 74).

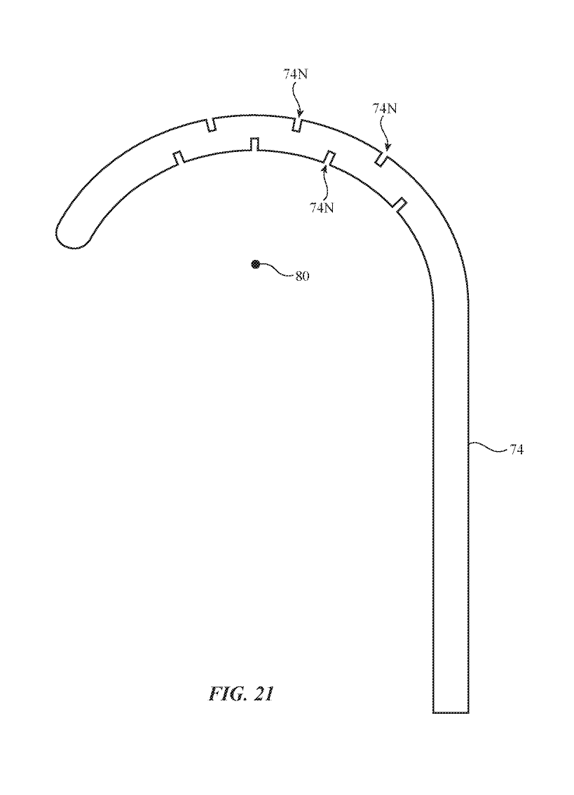

As shown in the illustrative configuration of FIG. 21, flexible printed circuit substrate 74 may have flexibility enhancement structures such as notches 74N or other recesses that help flexible printed circuit 74 bend about bend axis 80 (e.g., to accommodate bending of ear hook 42 by a user).

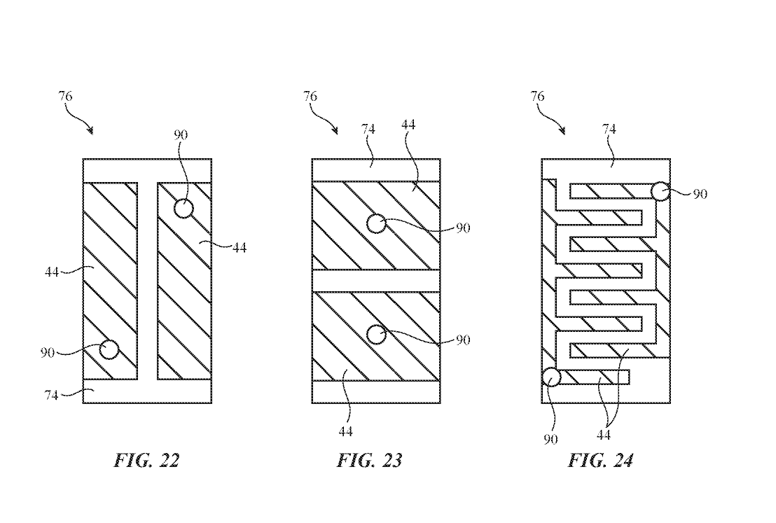

FIGS. 22, 23, and 24 show illustrative patterns for electrodes 44 on flexible printed circuit substrate 74 of flexible printed circuit 76. Electrodes 44 of FIG. 22 are opposed across the width of substrate 74 (e.g., across the width of ear hook 42). Electrodes 44 of FIG. 23 are opposed along the length of substrate 74. Electrodes 44 of FIG. 24 have interleaved fingers. Electrodes 44 of FIGS. 22, 23, and 24 may be shorted to flexible printed circuit signal lines (e.g., metal traces in different layers of flexible printed circuit 76) using vias 90.

If desired, the structures of FIGS. 22, 23, and 24 may be used in forming segmented electrodes. For example, electrodes 44 of FIG. 22 may be repeated along the length of substrate 74, electrodes 44 of FIG. 23 may be repeated along the length of substrate 74, and/or electrodes 44 of FIG. 24 may be repeated along the length of substrate 74.

Capacitive sensors 60 have been illustrated in connection with ear hooks for ear phones 24. If desired, the capacitive sensors formed from electrodes 44 may be used in other devices. For example, bendable member 68, conductive polymer 72, metal traces, wires, and other structures for forming electrodes 44 may form internal structures in a bracelet, a watch band, arm band, or other wearable device. The use of electrodes 44 in an ear hook such as ear hook 42 for ear phones 24 is illustrative.

The foregoing is merely illustrative and various modifications can be made to the described embodiments. The foregoing embodiments may be implemented individually or in any combination.

What is claimed is:

1. An earphone, comprising:
a housing;
a speaker in the housing;
a bendable ear hook configured to support the housing adjacent to an ear of a user, wherein the bendable ear hook includes at least one capacitive sensor electrode; and
a capacitance-to-digital converter coupled to the capacitive sensor electrode.

2. The earphone defined in claim 1 wherein the bendable ear hook comprises insulating polymer and wherein the capacitive sensor electrode is at least partly embedded in the insulating polymer.

3. The earphone defined in claim 2 wherein the capacitive sensor electrode comprises a metal traces on a flexible printed circuit embedded in the insulating polymer.

4. The earphone defined in claim 3 wherein the flexible printed circuit has a tab and wherein the capacitive sensor electrode is formed on the tab.

5. The earphone defined in claim 3 wherein the flexible printed circuit has flexibility enhancement recesses.

6. The earphone defined in claim 3 further comprising conductive polymer shorted to the metal traces.

7. The earphone defined in claim 2 wherein the capacitive sensor electrode comprises conductive polymer.

8. The earphone defined in claim 7 wherein the insulating polymer comprises an elastomeric polymer and wherein the capacitive sensor electrode includes a bendable metal member configured to hold the elastomeric polymer in a bent shape.

9. The earphone defined in claim 1 further comprising a bendable wire in the bendable ear hook that forms at least part of the capacitive sensor electrode.

10. The earphone defined in claim 9 further comprising conductive polymer shorted to the bendable wire.

11. The earphone defined in claim 10 wherein the bendable wire is configured to hold the bendable ear hook in a given bent shape after bending of the bendable wire.

12. The earphone defined in claim 1 wherein the at least one capacitive sensor electrode includes drive and sense electrodes.

13. The earphone defined in claim 12 wherein the at least one capacitive electrode further comprises a shield electrode.

14. The earphone defined in claim 1 further comprising optical proximity sensors in the housing.

15. The earphone defined in claim 14 further comprising control circuitry, wherein the control circuitry is configured to gather an optical proximity sensor reaching from the optical proximity sensor in response to detection of a capacitance with the capacitive sensor electrode and the capacitance-to-digital converter.

16. An earphone, comprising:
a housing;
a speaker in the housing;
an ear hook having a bendable metal structural member surrounded by insulating elastomeric polymer; and
capacitive sensor electrodes in the elastomeric polymer that are configured to detect presence of an ear adjacent to the ear hook.

17. The earphone defined in claim 16 wherein the capacitive sensor electrodes comprise metal traces on a flexible printed circuit.

18. The earphone defined in claim 16 wherein the capacitive sensor electrodes comprises conductive polymer.

19. An electronic device, comprising:
an insulating elastomeric polymer;
a bendable metal wire embedded in the insulating elastomeric polymer, wherein the bendable metal wire is configured to hold a bent shape when bent by a user;
a capacitive sensor electrode embedded in the insulating elastomeric polymer; and
a capacitance-to-digital converter that receives a capacitance measurement from the capacitive sensor electrode.

20. The electronic device defined in claim 19 wherein the capacitive sensor electrode is segmented.
